(19) United States
(12) Patent Application Publication
(10) Pub. No.: US 2011/0087836 A1
(43) Pub. Date: Apr. 14, 2011

(54) STORAGE UNIT AND MEMORY SYSTEM

(75) Inventors: Kenichi Nakanishi, Tokyo (JP); Keiichi Tsutsui, Tokyo (JP); Junichi Koshiyama, Tokyo (JP)

(73) Assignee: SONY CORPORATION, Tokyo (JP)

(21) Appl. No.: 12/897,990

(22) Filed: Oct. 5, 2010

(30) Foreign Application Priority Data
Oct. 14, 2009 (JP) 2009-237503

(51) Int. Cl. G06F 12/08; G06F 12/00

(52) U.S. Cl. 711/113; 711/E12.001; 711/E12.019

(57) ABSTRACT

A storage unit includes: a random access memory device and a storage device to be accessed using an address in units of word and sector, respectively; and a storage controller controlling accesses to the random access memory device and the storage device according to the addresses designated via a bus. The storage controller includes first and second interface functions for access to data stored on the storage device and the random access memory designated using the sector address and the word address provided via the bus, respectively, a function of using the random access memory device as a first disk cache and determining data to be saved in the random access memory device in response to the access by the first interface function, and functions of transferring the data designated using the sector address by repeating register access and by a bus master function as continuous word-sized data through the bus.

### BACKGROUND OF THE INVENTION

1. Field of the Invention

The present invention relates to a storage unit having a nonvolatile memory device and a random access memory and a memory system.

2. Description of the Related Art

In related art, there has been a very large difference in speed between a storage and a memory. As the memory speed becomes higher, the difference is getting larger and becomes problematic in improvements of performance of the whole system.

Accordingly, in order to reduce the difference, the memory is used as a disk cache.

Sector data that has recently been accessed may be left on the memory and, when the next access request is made, if the information is present in the cache, the information may be read in from the memory without access to the storage.

This shows a great effect when the same sector data is read out at many times and many small data are written in.

In practice, a storage unit represented by an HDD and an SDD contains a random access memory device (RAMD) and uses it as a first disk cache.

Further, in a system in related art, a part of the main memory is used as a second disk cache. The second disk cache is different from the first disk cache and a disk cache directly managed by a CPU.

Note that the data existing in the second disk cache is data read in from the storage unit via the first cache.

Technologies for effectively using cache memories are disclosed in JP-A-1994-161897 and JP-A-2008-026970.

A disk cache unit disclosed in JP-A-1994-161897 has a soft cache region for control data on a main memory device (main memory).

Further, a disc controller has a data determining means and improves cache utilization by not holding data that has been determined to be the control data on the cache memory.

This technology can prevent duplication of data in the first disk cache and the second disk cache.

A storage unit disclosed in JP-A-2008-026970 has a region notification command for designating a file region for fixation of a cache from a host, and transmits the region notification command during execution of a read command. Then, the storage unit fixes the data transferred until the region notification command is transmitted again onto the cache memory.

This technology can easily fix a particular region of the file in the cache memory.

### SUMMARY OF THE INVENTION

However, the data on the RAMD is managed within the storage based on the generated access request, and direct operation from the host may be impossible.

Further, the data existing in the second disk cache is data read in from the storage unit via the first cache.

That is, the condition that the same data exists in the two disk caches constantly occurs.

In this manner, the two disk caches are independently controlled.

Thus, the data loaded on the second disk cache concurrently exists also in the first disk cache, and the use efficiency of the memory is lowered and, consequently, the performance improvement effect is also lowered.

On the other hand, the second disk cache consumes the main memory, and the work memory becomes smaller.

In the case of work memory shortage, the operating system (OS) of the system generates storage access by swapping operation, and that causes reduction of performance of the system operation.

Further, in a system booted from the storage, access to the storage is started after initialization of the CPU module, and many data accesses are concentrated on the storage. Furthermore, there is a disadvantage that the effect of the disk cache is not obtained for the data to be accessed only at start-up.

In the technology disclosed in JP-A-1994-161897, data not held is designated, and it maybe impossible to read-ahead the data in the cache memory in advance or realize speed-up by the read-ahead at start-up.

In this technology, the controller has no memory interface accessible to the cache memory. Accordingly, data transfer is indispensable before access to data, codes, and becomes overhead.

In the technology disclosed in JP-A-2008-026970, in the case of bus master transfer, it may be impossible for the CPU to grasp the progress of data transfer and it maybe difficult to send a region notification command.

Further, in this technology, a region notification command for designation of the data to be fixed to the cache memory during data transfer is sent. Accordingly, in the case where the start of data transfer is impossible because the previous processing is in execution, it may be impossible to prepare the next data on the cache or realize speed-up by read-ahead.

Furthermore, the controller has no memory interface accessible to the cache memory. Accordingly, data transfer is indispensable before access to data, codes, and becomes overhead.

Thus, it is desirable to provide a storage unit and a memory system that can shorten the start time of the system and the time to start codes without necessity of data, codes to be transferred onto the main memory, and realize speed-up of the processing of the whole system.

A storage unit according to one embodiment of the invention includes a random access memory device to be accessed using an address in units of word, a storage device to be accessed using an address in units of sector, and a storage controller that controls accesses to the random access memory device and the storage device according to the addresses designated via a bus, wherein the storage controller includes a first interface function for access to data stored on the storage device designated using the sector address provided via the bus, a second interface function for direct access to data on the random access memory device using the word address designated via the bus, a function of using the random access memory device as a first disk cache and determining data to be saved in the random access memory device in response to the access by the first interface function, a function of transferring the data designated using the sector address by repeating register access, and a function of transferring the data designated using the sector address by a bus master function as continuous word-sized data through the bus.

A memory system according to another embodiment of the invention includes a host, a main memory module, a storage unit accessed by the host, and a system bus connecting the host, the main memory module, and the storage unit, wherein the storage unit includes a random access memory device to be accessed using an address in units of word, a storage device to be accessed using an address in units of sector, and a storage controller that controls accesses to the random access memory device and the storage device according to the addresses designated via the system bus, and wherein the storage controller includes a first interface function for access to data stored on the storage device designated using the sector address according to an instruction from the host via the system bus, a second interface function by the host for direct access to data on the random access memory device using the word address designated via the system bus, a function of using the random access memory device as a first disk cache and determining data to be saved in the random access memory device in response to the access by the first interface function, a function of transferring the data designated using the sector address by repeating register access, and a function of transferring the data designated using the sector address by a bus master function as continuous word-sized data between the main memory module and itself through the system bus.

According to the embodiments of the invention, data, codes to be transferred onto the main memory are unnecessary, the start time of the system and the time to start codes can be shortened, and speed-up of the processing of the whole system can be realized.

### BRIEF DESCRIPTION OF THE DRAWINGS

FIG. 1 shows a configuration example of a memory system including a storage unit according to a first embodiment of the invention.

FIG. 2 is a block diagram of a memory system as a comparative example.

FIG. 3 shows a basic internal configuration of an STGC in the comparative example.

FIG. 4 shows a basic internal configuration of an STGC according to the embodiment of the invention.

FIG. 5 shows a first configuration example of an STGC directly accessible from a CPU to a disk cache in the embodiment.

FIG. 6 shows a second configuration example of the STGC directly accessible from the CPU to the disk cache in the embodiment.

FIG. 7 shows memory maps seen from system buses of the embodiment and the comparative example.

FIG. 8 shows a configuration example of a control register CTRL_REG that controls the STGC according to the embodiment.

FIG. 9 shows details of an error register in the control register.

FIG. 10 shows details of a status register in the control register.

FIG. 11 shows a configuration example of a bus master register BM_REG that controls the STGC.

FIG. 12 shows details of a bus master command register in the bus master register.

FIG. 13 shows details of a bus master status register in the bus master register.

FIG. 14 shows details of a PRD table.

FIG. 15 shows a flowchart when a read command is executed as an example of a sequence in the case where the STGC (storage controller) of the embodiment is controlled from the system bus.

FIG. 16 shows an example of values set in the respective registers when the read command is executed in response to the flowchart in FIG. 15.

FIG. 17 shows a flowchart when a write command is executed as an example of the sequence in the case where the STGC (storage controller) of the embodiment is controlled from the system bus.

FIG. 18 shows an example of values set in the respective registers when the write command is executed in response to the flowchart in FIG. 17.

FIG. 19 shows a flowchart when a set cache command is executed as an example of the sequence in the case where the STGC (storage controller) of the embodiment is controlled from the system bus.

FIG. 20 shows an example of values set in the respective registers when the set cache command is executed in response to the flowchart in FIG. 19.

FIG. 21 shows a flowchart when a release cache command is executed as an example of the sequence in the case where the STGC (storage controller) of the embodiment is controlled from the system bus.

FIG. 22 shows an example of values set in the respective registers when the release cache command is executed in response to the flowchart in FIG. 21.

FIG. 23 is a diagram for explanation of an example of management information of a disk cache region necessary for realization of the functions as in FIGS. 15 to 22.

FIG. 24 shows a flowchart describing an STGC internal operation of the read command.

FIG. 25 shows a flowchart describing an STGC internal operation of the write command.

FIG. 26 shows a flowchart describing an STGC internal operation of cache out processing.

FIG. 27 shows a flowchart describing an STGC internal operation of the set cache command.

FIG. 28 shows a flowchart describing an STGC internal operation of the release cache command.

FIG. 29 is a diagram describing and showing effects of the embodiment of the invention by comparison of times from read in of codes saved on a storage onto a memory to execution from the CPU.

FIG. 30 shows a flowchart describing an operation performed in the STGC when reset of a storage module is released for start-up.

FIG. 31 shows effects of functions of automatically loading initial values of cache management information of the embodiment.

FIG. 32 shows a configuration example of a memory system including a storage unit according to a second embodiment of the invention.

### DESCRIPTION OF PREFERRED EMBODIMENTS

Hereinafter, the embodiments of the invention will be explained with reference to the drawings.

The explanation will be made in the following order.

1. First Embodiment

2. Second Embodiment

### 1. First Embodiment

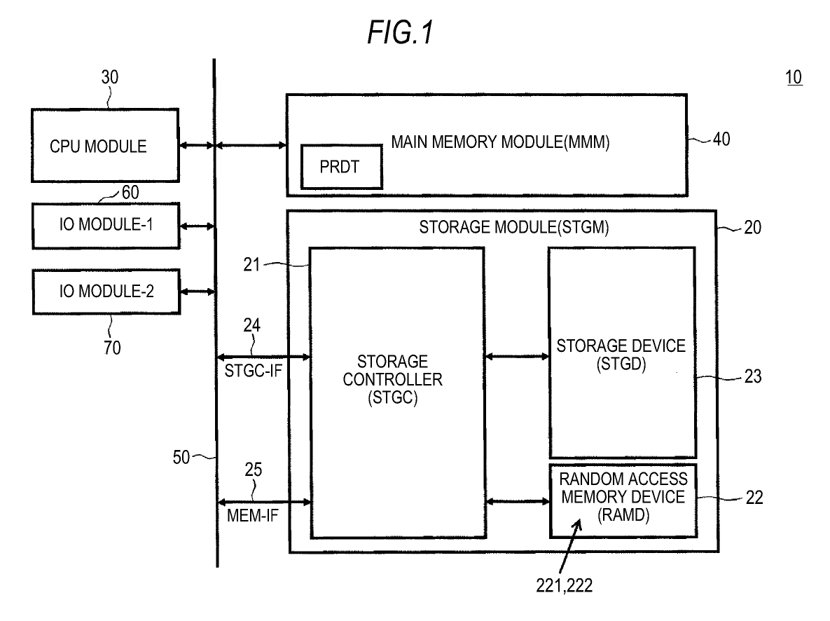

FIG. 1 shows a configuration example of a memory system including a storage unit according to the first embodiment of the invention.

A memory system 10 according to the first embodiment has a storage module 20, a CPU module (CPU) 30 as a host, a main memory module (MMM) 40, a system bus 50, and IO modules 60, 70.

The storage module 20, the CPU 30, the MMM 40, and the IO modules 60, 70 are connected by the system bus 50.

The storage module (STGM) 20 according to the first embodiment includes a storage controller (STGC) 21, a random access memory device (RAMD) 22, and a storage device (STGD) 23.

The RAMD 22 is accessed using an address in units of word and the STGD 23 is accessed using an address in units of sector.

The STGC 21 has two interface functions of connecting to a bus accessible from the CPU 30.

The STGC 21 has a storage interface (STGC-IF) 24 as a first interface function and a memory interface (MEM-IF) 25 as a second interface function.

Further, the STGM 20 is connected to the system bus 50 by the storage interface (STGC-IF) 24 and the memory interface (MEM-IF) 25.

The STGC-IF 24 provides an interface for access to data stored on the STGD 23 designated using a sector address according to an instruction from the CPU 30.

Here, the data designated using the sector address is transferred by repeated register accesses of the STGC 21, and otherwise, transferred at a high speed as continuous word-sized data between the MMM 40 and itself by a bus master function.

In response to the access from the STGC-IF 24, the STGC 21 uses the RAMD 22 as a first disk cache and the STGC 21 determines data to be saved on the RAMD 22.

The MEM-IF 25 provides an interface by the CPU 30 for direct access to the data on the RAMD 22 using a word address.

The STGC 21 of the embodiment has a cache designation function of designating the data held on the RAMD 22 and a cache releasing function of releasing the designation by the CPU 30 as a second disk cache.

The cache designation function is instructed to the STGC 21 via the STGC-IF 24 as the first interface.

The instruction contains information on an address and a data size of the STGD 23.

The STGC 21 performs processing of securing a region having a designated data size from an unused region on the RAMD 22 and writing data having an address designated from the STGD 23 in the region that has been secured in advance.

The cash release function is instructed to the STGC 21 via the STGC-IF 24 as the first interface.

The instruction contains information on the address of the STGD 23, and the STGC 21 determines, with respect to the designated data region on the RAMD 22, whether the data is held on the RAMD 22 after the release instruction by the judgment of the STGC 21.

In the embodiment, the data held as the second disk cache is also used as the first disk cache.

The STGC 21 has a function of switching to the data of the second disk cache if the data designated as the second disk cache has already existed on the RAMD 22 as the first disk cache.

The STGC 21 performs processing of writing back the data held on the RAMD 22 as the first disk cache in the STGC 23 by the judgment of the STGC 21.

The STGC 21 continues to hold the data held on the RAMD 22 as the second disk cache until receiving the release instruction from the CPU 30.

The STGC 21 has a switch (ARBT), which will be described later, for switching between a signal for the STGC 21 to transmit access as the first disk cache to the RAMD 22 and a signal to directly transmit access as the second disk cache from the CPU bus.

The STGC 21 has a function of holding cache management information in a nonvolatile memory and a function of reproducing instructions held in the nonvolatile memory at start-up of the STGM 20.

Note that the nonvolatile memory may be a part of the STGD 23.

In the embodiment, as a device in combination of the STGD 23 and the RAMD 22 as memory modules, a nonvolatile random access memory (NVRAM) may be used.

In this case, by providing a path directly accessing to the NVRAM from the MEM-IF 25 via the ARBT, data transfer within the STGC 21 may be unnecessary and further speed-up may be realized.

As below, the memory system 10 according to the embodiment will specifically be explained by focusing attention on the configuration and the functions of the STGM 20 while comparing it with a general system according to need.

Note that, for easy understanding, the same signs of component elements of the embodiment are assigned to those of comparison examples for explanation as below.

In the memory system 10, the STGC 21 is controlled as a storage device by being accessed to a register (not shown) by the CPU 30 via the STGC-IF 24, and performs data transfer using the bus master function that the STGC 21 has.

The STGD 23 is used as a nonvolatile data storage region, and the RAMD 22 is used as a cache region of the data input and output between the STGD 23 and the STGC 21.

The MEM-IF 25 provides a function of accessing to the RAMD 22 as a memory from the CPU 30.

In the embodiment, the data held in the cache region is directly accessed without being transferred to the main memory.

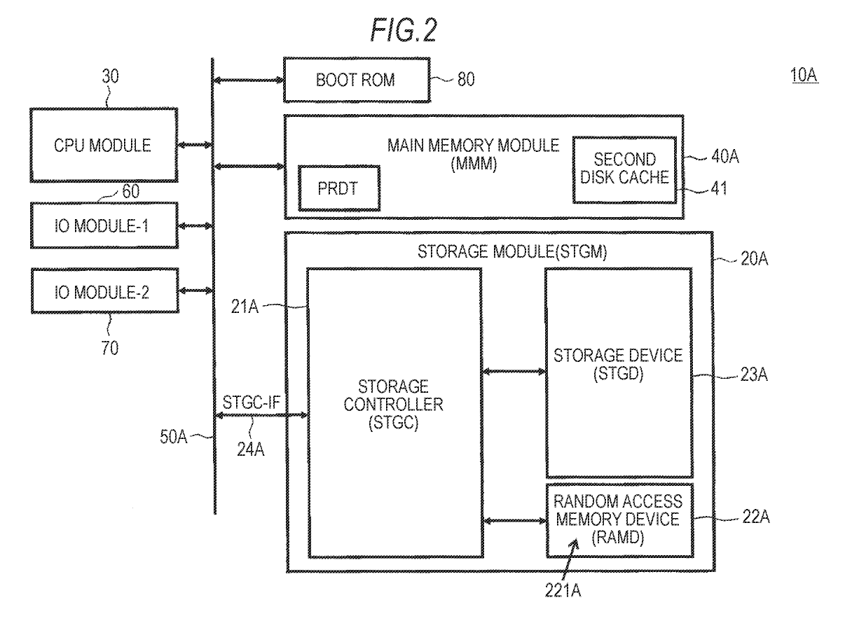

FIG. 2 is a block diagram of a memory system as a comparative example.

In the memory system 10A, an STGM 20A is connected to a system. bus 50A via an STGC-IF 24A and has no function of the MEM-IF.

In the memory system 10A of the comparative example, in addition to a first disk cache 221 that the system has within the storage module (STGM) 20A, a second disk cache region 41 is secured on a main memory module (MMM) 40A and used.

A first disk cache region 221A is a cache region controlled by an STGC 21A based on access information for the STGM 20A and access performance of an STGD 23A.

On the other hand, the second disk cache region 41 is a cache region managed by the CPU 30 according to requests of an OS and applications.

The STGM 20 of the embodiment is characterized by using the contained disk cache region for both the first disk cache 221 and a second disk cache 222.

The management of the disk cache region is performed by the STGC 21, and which sector exists in which disk cache may be determined by the CPU 30 because address information is output to the CPU 30 when allocation of the second disk cache 222 is requested.

The disk cache no longer necessary may be released.

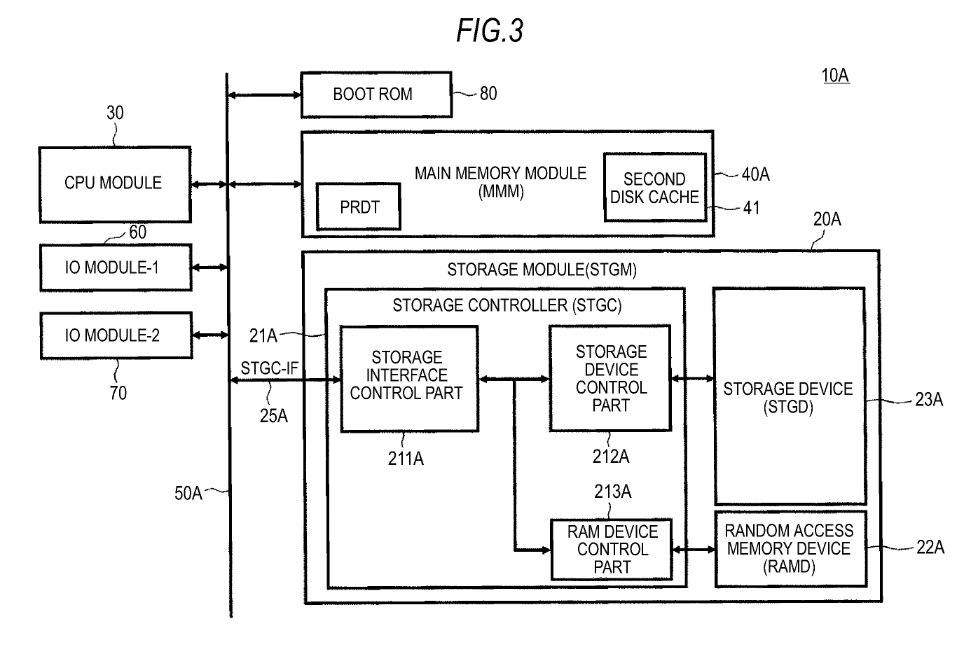

FIG. 3 shows a basic internal configuration of an STGC in the comparative example.

The STGC 21A has a storage interface control part 211A that controls an interface with the system bus 50A, a storage device control part 212A that controls the STGD 23A, and a RAM device control part 213A that controls the RAMD 22A.

Further, the three control parts 211A, 212A, 213A are connected by one internal bus.

### [Basic Internal Configuration of the STGC]

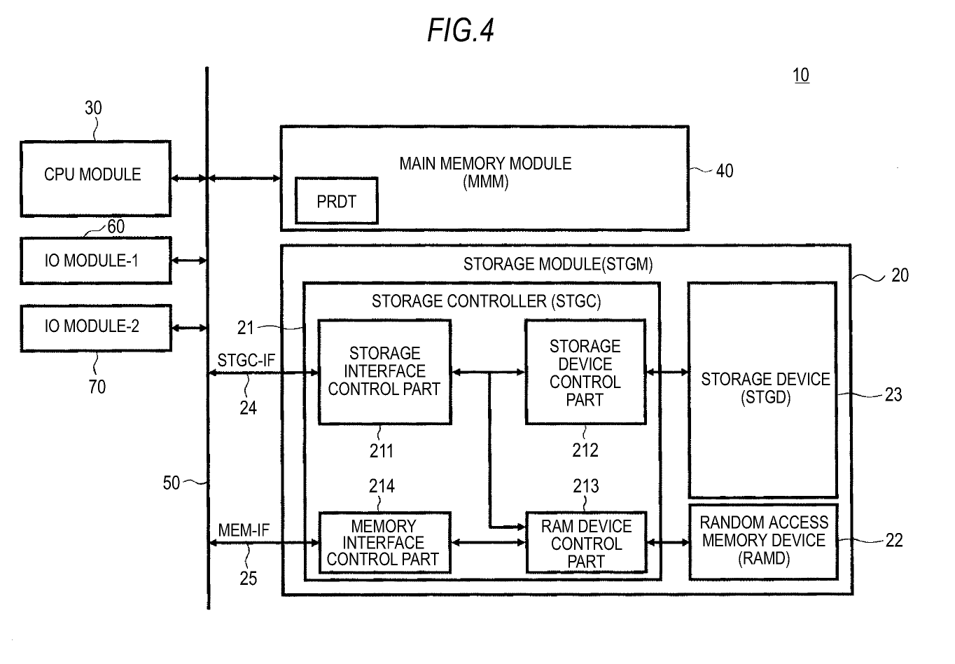

FIG. 4 shows a basic internal configuration of the STGC according to the embodiment of the invention.

The STGC 21 has a storage interface control part 211 that controls an interface between the STGC-IF 24 and the system bus 50, a storage device control part 212 that controls the STGD 23, and a RAM device control part 213 that controls the RAMD.

Further, the STGC 21 has a memory interface control part 214 that controls an interface between the MEM-IF 25 and the system bus 50.

In the STGC 21 of the embodiment, the RAM device control part 213 is connected to the memory interface control part 214 in addition to the same internal bus as that of the STGC 21A of the comparative example.

[Configuration Example of RAMD Access from CPU]

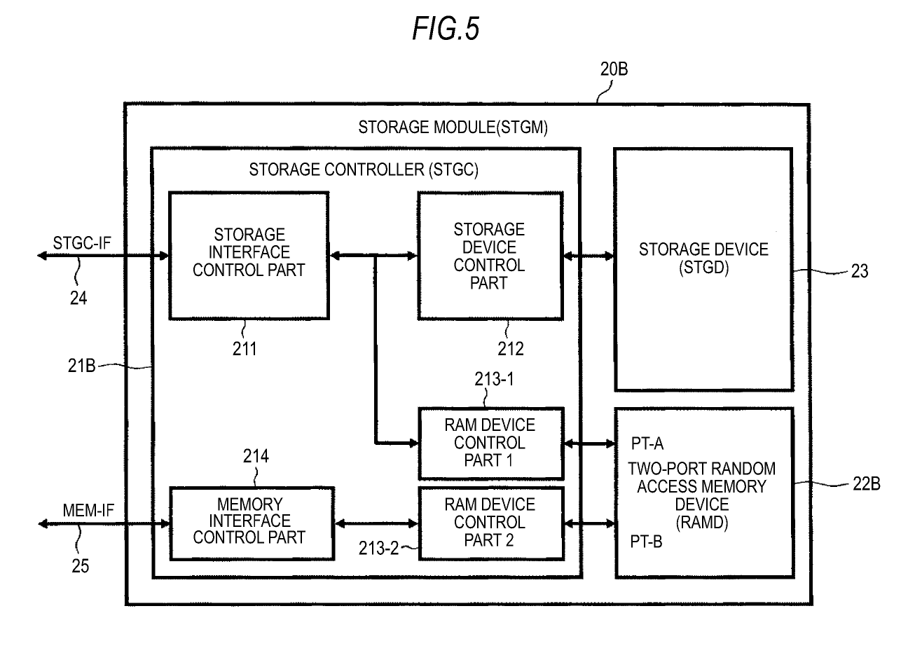

FIG. 5 shows a first configuration example of an STGC directly accessible from a CPU to a disk cache in the embodiment.

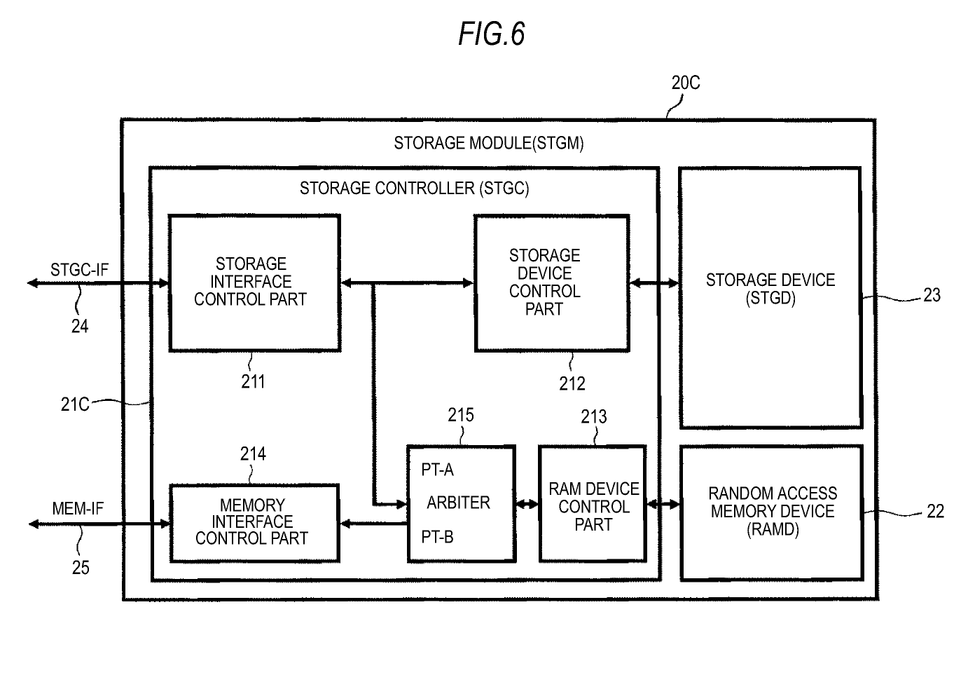

FIG. 6 shows a second configuration example of the STGC directly accessible from the CPU to the disk cache in the embodiment.

The first configuration example of FIG. 5 is the case where a memory having two random access ports PT-A, PT-B is mounted as a RAMD 22B.

In response, an STGC 21B has two RAM device control parts 213-1, 213-2.

The RAM device control part 213-1 is connected between the random access port PT-A of the RAMD 22B and the storage interface control part 211 and the RAM device control part 213.

The RAM device control part 213-2 is connected between the random access port PT-B of the RAMD 22B and the memory interface control part 214.

The case of the second configuration example of FIG. 6 is an example having an arbiter 215 including two ports at the upstream of the RAM device control part 213 and an arbitration mechanism of an access by the CPU 30 via the MEM-IF 25 and an access within an STGC 21C.

The arbiter 215 has a port PT-A connected to the storage interface control part 211 and the storage device control part 212, and a port PT-B connected to the memory interface control part 214.

When the two accesses conflict with each other, the arbiter 215 gives priority to the access via the MEM-IF 25 at the port PT-B side and prevents delay of processing of the CPU 30.

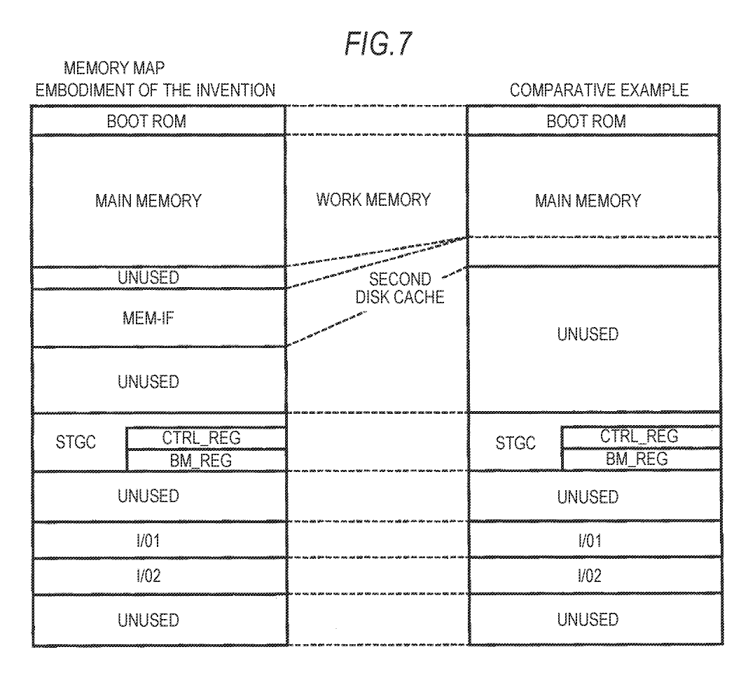

FIG. 7 shows memory maps seen from system buses of the embodiment and the comparative example.

Each bus has a control register CTRL_REG and a bus master register BM_REG as registers that control the STGC.

The memory map of the embodiment has an address space to be accessed from the MEM-IF 25. Using this space as the second disk cache region, the data transfer time to the MMM 40 as the main memory may be unnecessary and consumption of the main memory may be unnecessary.

### [Configuration Example of Control Register]

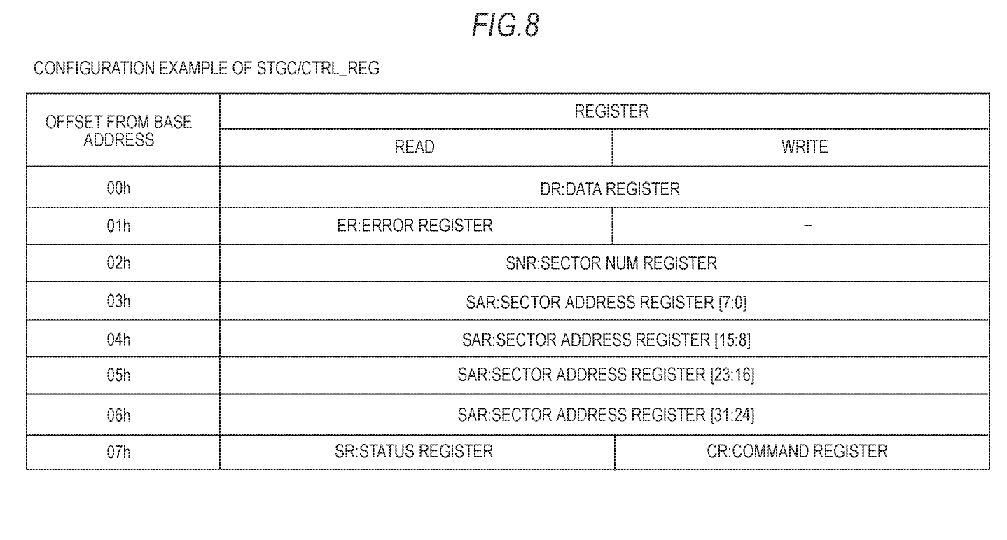

FIG. 8 shows a configuration example of the control register CTRL_REG that controls the STGC according to the embodiment.

In the example, a register is assigned for every 8 bits, and partially, registers to be accessed are switched at read and write.

A data register DR is a register for data transfer to and from the CPU, and writes at data transfer from the CPU 30 to the STGC 21 and reads at data transfer from the STGC 21 to the CPU 30.

An error register ER is a register that, when a status register SR, which will be described later, gives notification of occurrence of an error, shows a cause thereof for read only.

A sector num register SNR is a register that sets the sector number to be transferred. In this example, since the register has 8 bits, 255 sectors at the maximum may be designated.

A sector address register SAR is a register that sets a head sector address to be accessed. In this example, 32-bit address at the maximum may be designated.

The status register SR is a register showing an operation status of the STGC 21 for read only.

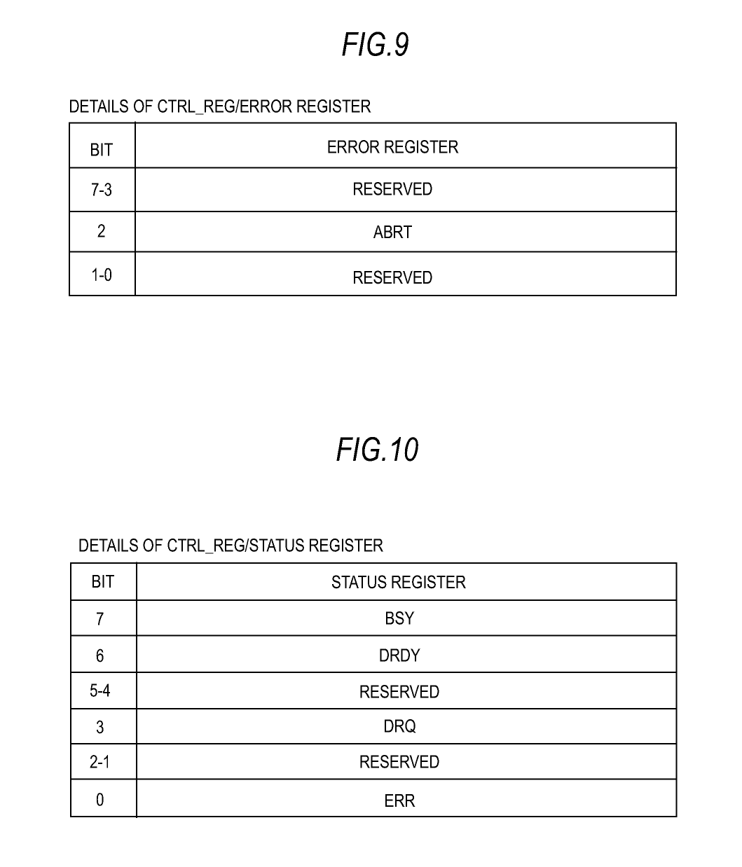

FIG. 9 shows details of the error register in the control register.

ABRT means “abort” and becomes “1” when transfer in interrupted in the middle.

FIG. 10 shows details of the status register in the control register.

BSY means “busy” and BSY=1 indicates that the STGC 21 is in command execution.

DRDY means “data ready” and DRDY=1 indicates that data is set in the data register DR and readable.

DRQ means “data request” and DRQ=1 indicates that the data register DR is empty and writable.

ERR means “error” and ERR=1 indicates that an error has occurred and the factor thereof may be confirmed from the value of the error register ER.

There are many systems having a mechanism of, when the value of the status register SR changes, issuing an interrupt signal to the CPU 30 to inform the status change, however, here, an example in which the status register SR is poled for confirmation will be explained.

A command register CR is a register that sets a command to the STGC 21 for write only.

Here, a value of 8 bits may be used as an operation code OC, and 256 kinds of commands can be defined at the maximum.

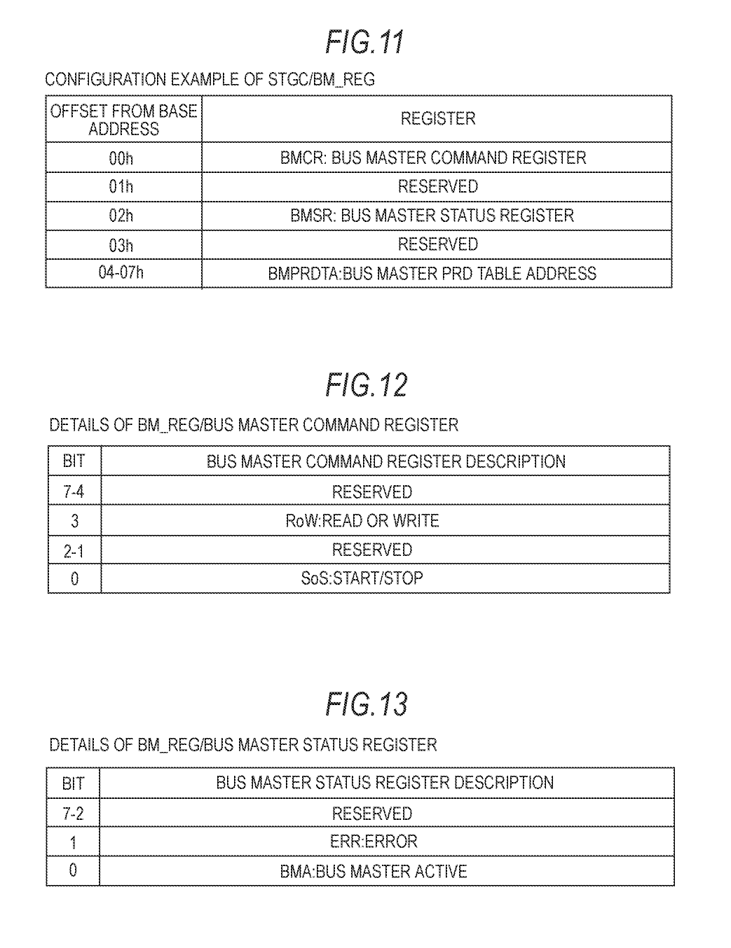

FIG. 11 shows a configuration example of the bus master register BM_REG that controls the STGC.

A bus master command register BMCR is a register for controlling access to the system bus 50 by the STGC 21 as a bus master.

A bus master status register BMSR is a register for showing a status that the STGC 21 operates as the bus master.

A bus master PRD table address register BMPRDTAR is a register for setting an address of a PRD (physical region descriptor) table PRDT prepared on the main memory.

The STGC 21 sequentially reads in PRDs from the PRD table PRDT, and performs data transfer based on address information written in the PRD table PRDT.

FIG. 12 shows details of the bus master command register in the bus master register.

Read or write RoW sets a direction of data transfer, and indicates read (data transfer from STGC to main memory)=0, write (data transfer from main memory to STGC)=1.

Start or stop SoS sets start and stop of the bus master operation, and start=1, stop=0.

FIG. 13 shows details of the bus master status register in the bus master register.

Error ERR indicates that data transfer has not been completed.

Bus master active BMA indicates that the bus master is in operation.

There are many systems having a mechanism of, when the value of the status register SR changes, issuing an interrupt signal to the CPU 30 to inform the status change, however, here, an example in which the status register SR is poled for confirmation will be explained.

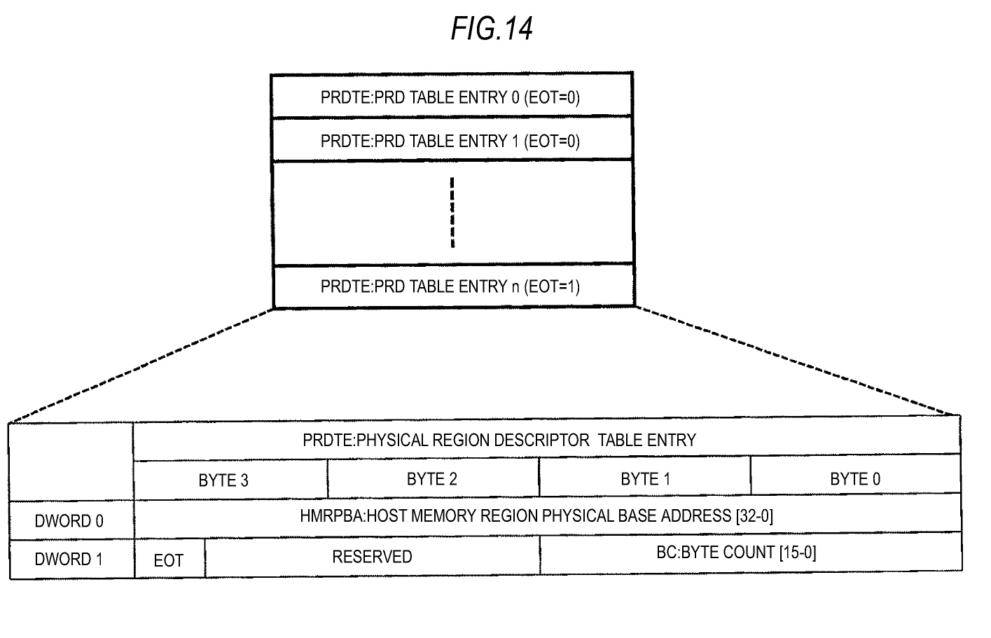

FIG. 14 shows details of the PRD table.

The PRD table PRDT is formed by plural PRD table entries PRDTEs and only the final entry is EOT=1.

The contents of the PRD table entry PRDTE include a host memory region physical base address HMRPBA indicating an address of the data region on the main memory.

Further, the contents of the PRD table entry PRDTE are formed by an EOT (end of table) indicating the final entry and a byte count BC indicating the size of the data region with bytes.

Note that the configurations of these control register CTRL_REG, bus master register BM_REG are general and do not show the features of the embodiment of the invention, and taken as means for specifically describing an implemented example of the invention.

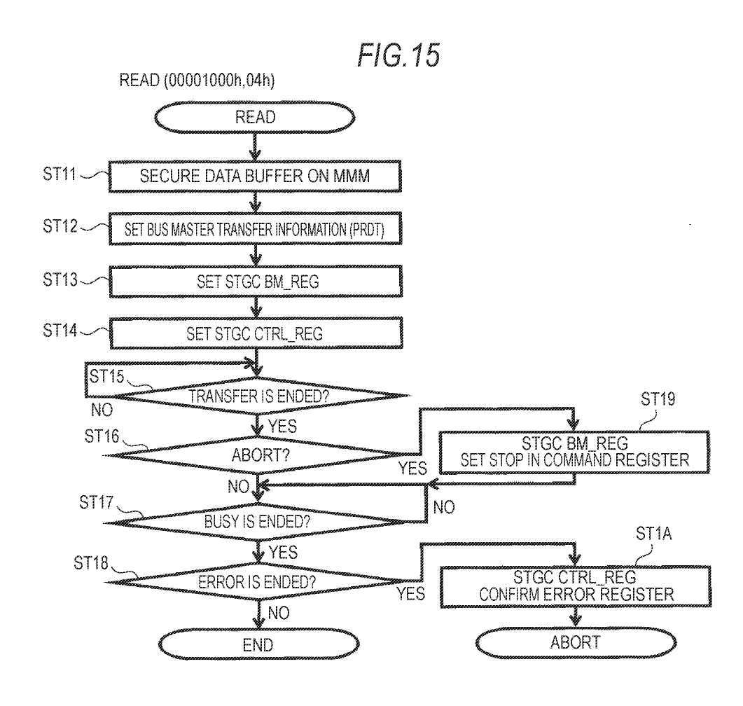

FIG. 15 shows a flowchart when a read command is executed as an example of a sequence in the case where the STGC (storage controller) of the embodiment is controlled from the system bus.

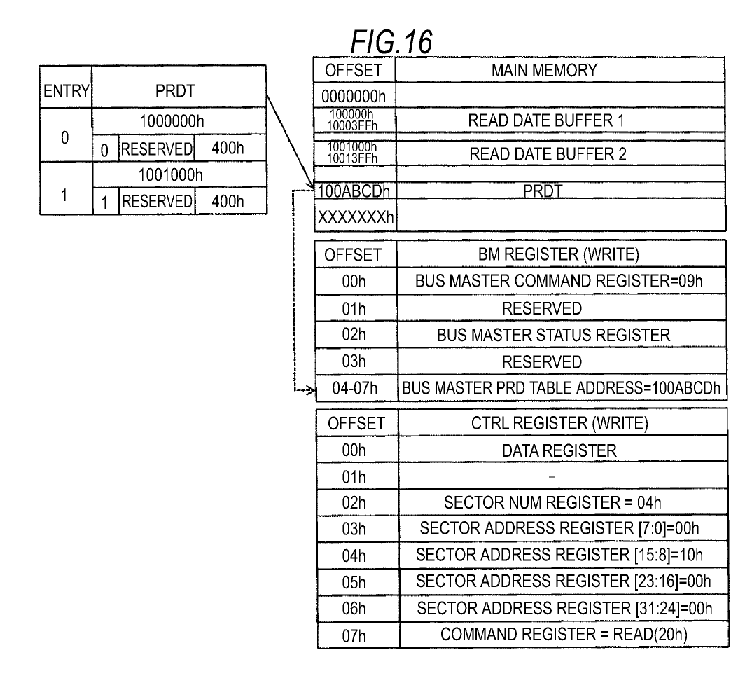

Further, FIG. 16 shows an example of values set in the respective registers when the read command is executed in response to the flowchart in FIG. 15.

At step ST11, the CPU 30 secures a buffer region for holding data read in from the STGM (storage module) 20 on the MMM 40.

A general CPU system uses a virtual memory, and the buffer region is not necessarily one continuous address space.

At step ST12, the PRD table PRDT is generated on the MMM 40 from the secured buffer region.

At step ST13, in the bus master register BM_REG of the STGC 21, the data transfer direction and start bit SoS, and the address of the MMM 40 in which the PRD table PRDT has been saved are set.

At step ST14, the sector number to be read in the control register CTRL_REG of the STGC 21, the head sector address, a read command code (0x20) are set.

The STGC 21 starts execution of the command and, when the data is prepared, starts transfer as the bus master.

After the start of transfer, the CPU 30 confirms the bus master operation of the STGC 21 by poling the bus master status register BMSR of the bus master register BM_REG.

At step ST15, the CPU 30 confirms the completion of the data transfer by the bus master active BMA=0.

At step ST16, the CPU 30 confirms the normal termination of the data transfer by the error bit ERR=0.

If the error bit ERR=1, at step ST19, the stop bit SoS=1 is set in the bus master command register BMCR of the bus master register BM_REG.

After the bus master transfer is completed, the CPU 30 confirms the operation of the STGC 21 by poling the status register SR of the control register CTRL_REG.

At step ST17, the CPU 30 confirms the end of the command by the busy bit BSY=0.

At step ST18, the CPU 30 confirms that the command execution result is normal by the error bit ERR=0.

If the error bit ERR is “1”, at step ST1A, the value of the error register ER of the control register CTRL_REG is confirmed and the status of the error (abort) is confirmed.

The accessed sector data is held as the first disk cache in the disk cache region.

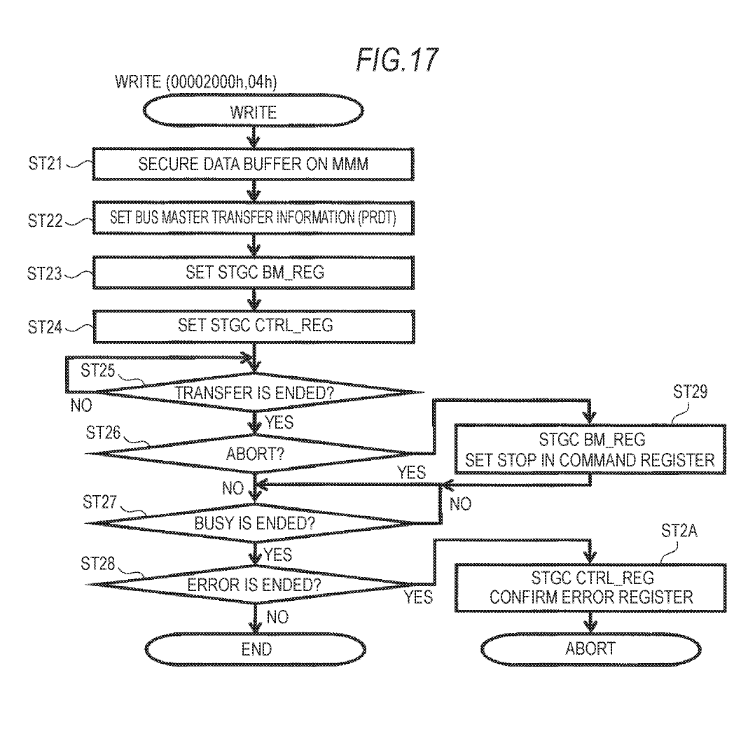

FIG. 17 shows a flowchart when a write command is executed as an example of the sequence in the case where the STGC (storage controller) of the embodiment is controlled from the system bus.

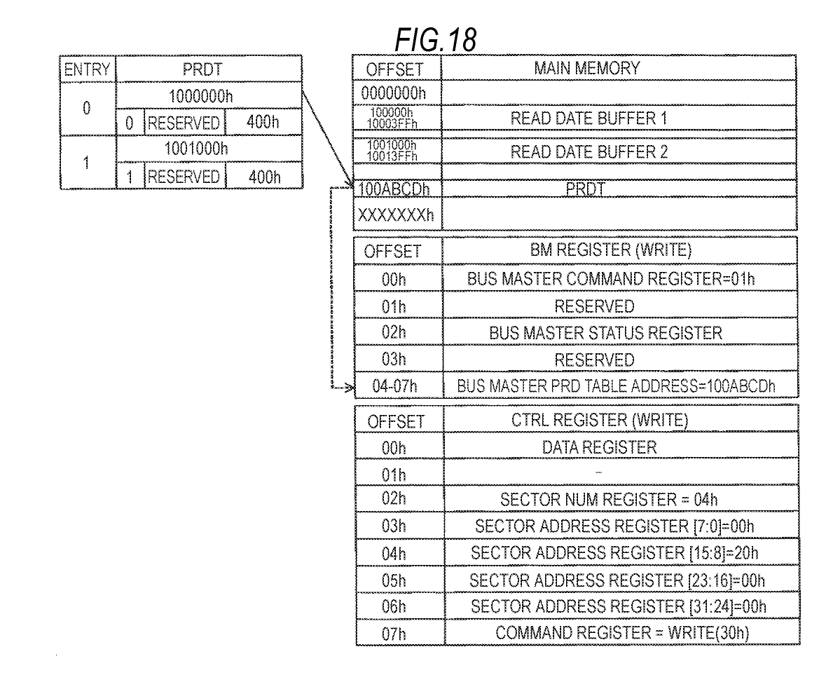

Further, FIG. 18 shows an example of values set in the respective registers when the write command is executed in response to the flowchart in FIG. 17.

At step ST21, the CPU 30 secures a buffer region for holding data to be written in the STGM (storage module) 20 on the MMM 40, and prepares write data.

A general CPU system uses a virtual memory, and the buffer region is not necessarily one continuous address space.

At step ST22, the PRD table PRDT is generated on the MMM 40 from the secured buffer region.

At step ST23, in the bus master register BM_REG, the data transfer direction and start bit SoS, and the address of the MMM 40 in which the PRD table PRDT has been saved are set.

At step ST24, the sector number to be written in the control register CTRL_REG of the STGC 21, the head sector address, a write command code (0x30) are set.

The STGC 21 starts execution of the command and, when the data is prepared for reception, starts transfer as the bus master.

After the start of transfer, the CPU 30 confirms the bus master operation of the STGC 21 by poling the bus master status register BMSR of the bus master register BM_REG.

At step ST25, the CPU 30 confirms the completion of the data transfer by the bus master active BMA=0.

At step ST26, the CPU 30 confirms the normal termination of the data transfer by the error bit ERR=0.

If the error bit ERR=1, at step ST29, the stop bit SoS=1 is set in the bus master command register BMCR of the bus master register BM_REG.

After the bus master transfer is completed, the CPU 30 confirms the operation of the STGC 21 by poling the status register SR of the control register CTRL_REG.

At step ST27, the CPU 30 confirms the end of the command by the busy bit BSY=0.

At step ST28, the CPU 30 confirms that the command execution result is normal by the error bit ERR=0.

If the error bit ERR is “1”, at step ST2A, the value of the error register ER of the control register CTRL_REG is confirmed and the status of the error (abort) is confirmed.

The accessed sector data is held as the first disk cache in the disk cache region.

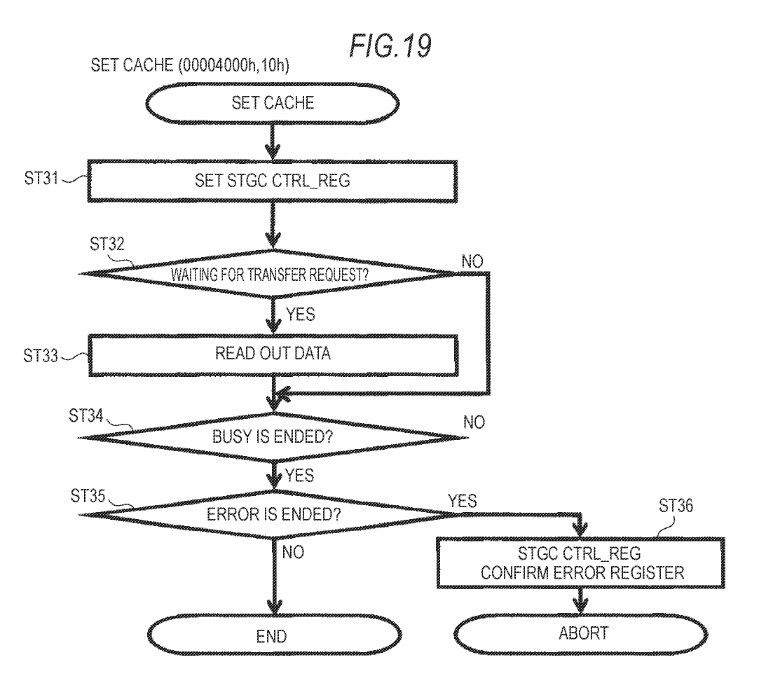

FIG. 19 shows a flowchart when a set cache command is executed as an example of the sequence in the case where the STGC (storage controller) of the embodiment is controlled from the system bus.

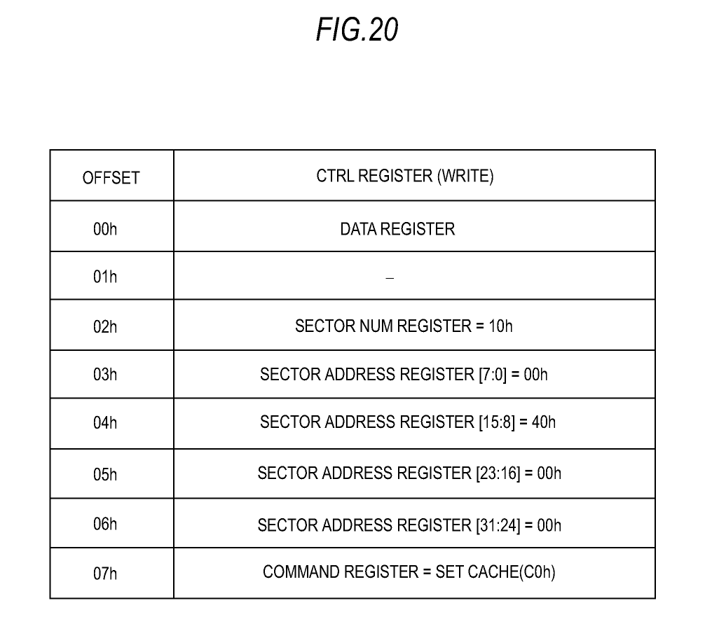

Further, FIG. 20 shows an example of values set in the respective registers when the set cache command is executed in response to the flowchart in FIG. 19.

At step ST31, the CPU 30 sets the sector number of the data to be read in as the second disk cache, the head sector address, and a command code (0xC0) of the sector cache in the control register CTRL_REG of the STGC 21.

The STGC 21 starts execution of the command, searches for a free space of the disk cache region on the RAMD 22, and reads in the designated data from the STGD 23.

After the start of execution of the command, the CPU 30 confirms the status register SR of the control register CTRL_REG by poling.

At step ST32, if the CPU 30 detects a data ready bit (DRDY bit) DRDY=1, the CPU 30 reads out the data register DR of the control register CTRL_REG at step ST33.

As an execution result of the set cache command, the STGC 21 outputs an address of the disk cache region in which the designated data has been assigned.

At step ST34, the CPU 30 confirms the end of the command by the busy bit BSY=0.

At step ST35, the CPU 30 confirms that the command execution result is normal by the error bit ERR=0.

If the error bit ERR is “1”, at step ST36, the value of the error register ER of the control register CTRL_REG is confirmed and the status of the error (abort, here cache assignation is failed) is confirmed.

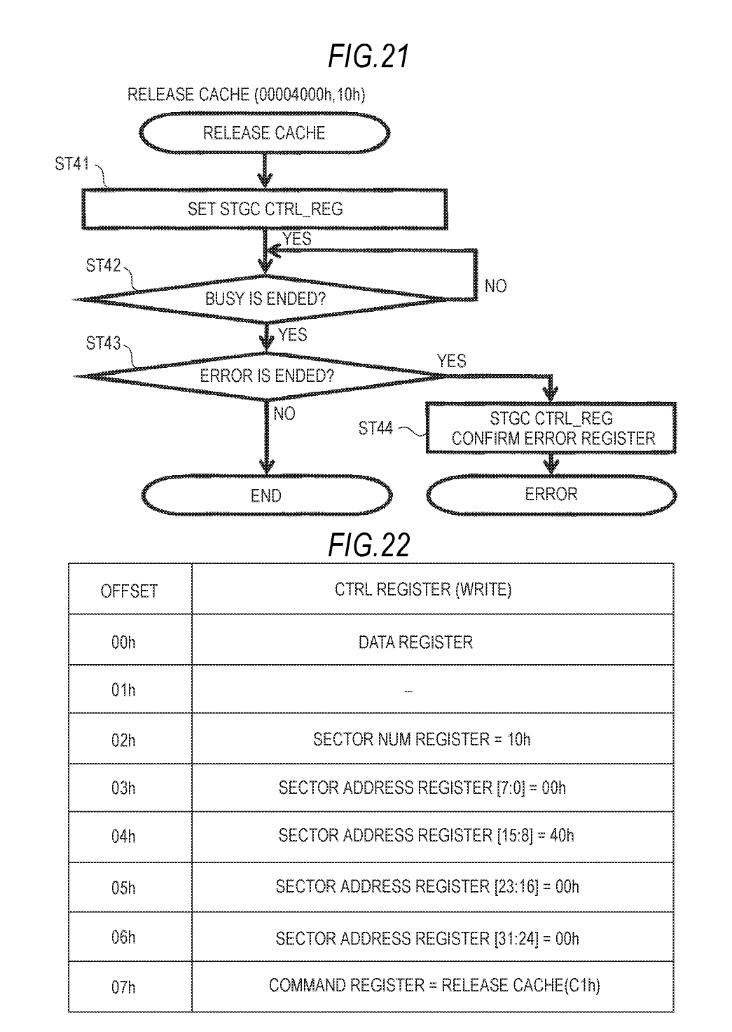

FIG. 21 shows a flowchart when a release cache command is executed as an example of the sequence in the case where the STGC (storage controller) of the embodiment is controlled from the system bus.

Further, FIG. 22 shows an example of values set in the respective registers when the release cache command is executed in response to the flowchart in FIG. 21.

At step ST41, the CPU 30 sets the sector number of the data no longer necessary as the second disk cache, the head sector address, and a command code (0xC1) of the release cache in the control register CTRL_REG of the STGC 21.

The STGC 21 starts execution of the command, searches for the disk cache region on the designated RAMD 22, and performs processing of cash out.

Using the data of the first disk cache, cache out may be performed when a free space of the disk cache region is run out.

After the start of execution of the command, the CPU 30 confirms the status register SR of the control register CTRL_REG by poling.

At step ST42, the CPU 30 confirms the end of the command by the busy bit BSY=0.

At step ST43, the CPU 30 confirms that the command execution result is normal by the error bit ERR=0.

If the error bit ERR is “1”, at step ST44, the value of the error register ER of the control register CTRL_REG is confirmed and the status of the error (abort, here cache assignation is failed) is confirmed.

Next, an example of management information of the disk cache region necessary for realization of the functions as in FIGS. 15 to 22 will be explained.

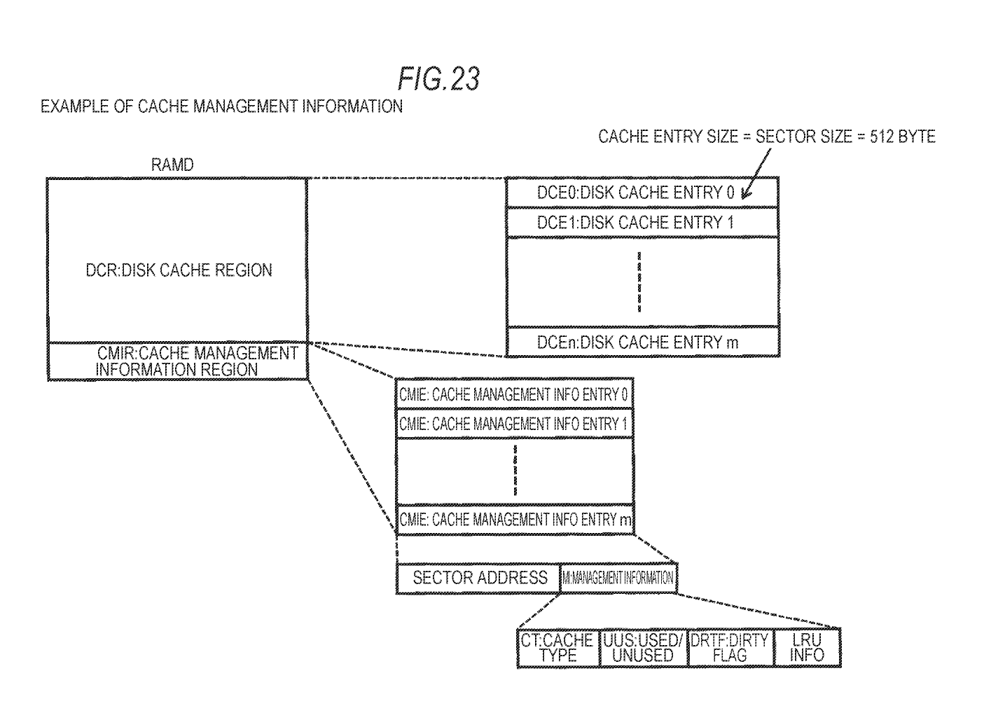

FIG. 23 is a diagram for explanation of the example of management information of the disk cache region necessary for realization of the functions as in FIGS. 15 to 22.

In this example, the STGC 21 uses the RAMD 22 as a work memory for cache management information CMI. The memory region on the RAMD 22 is formed by a region that holds data as a disk cache region DCR and a cache management information region CMIR.

The STGC 21 manages the disk cache region DCR using the cache management information CMI. The disk cache region DCR is managed as a disk cache entry DCE using 512 bytes as a unit.

The cache management information CMI includes plural cache management information entries CMIEs and the cache management information entry CMIE is formed by a sector address on the STGD 23 and management information MI.

The management information MI includes a cache type CT indicating whether the first disk cache or the second disk cache and used/unused UUS indicating whether being used or not.

The management information MI includes a dirty flag DRTF indicating whether the data has been changed by writing or not and LRU info as information used for selecting data for cache out.

Further, the memory interface control part 214 of the STGC 21 enables the access from the system bus 50 to the disk cache region DCR, but prohibits the access from the system bus 50 to the cache management information region CMIR.

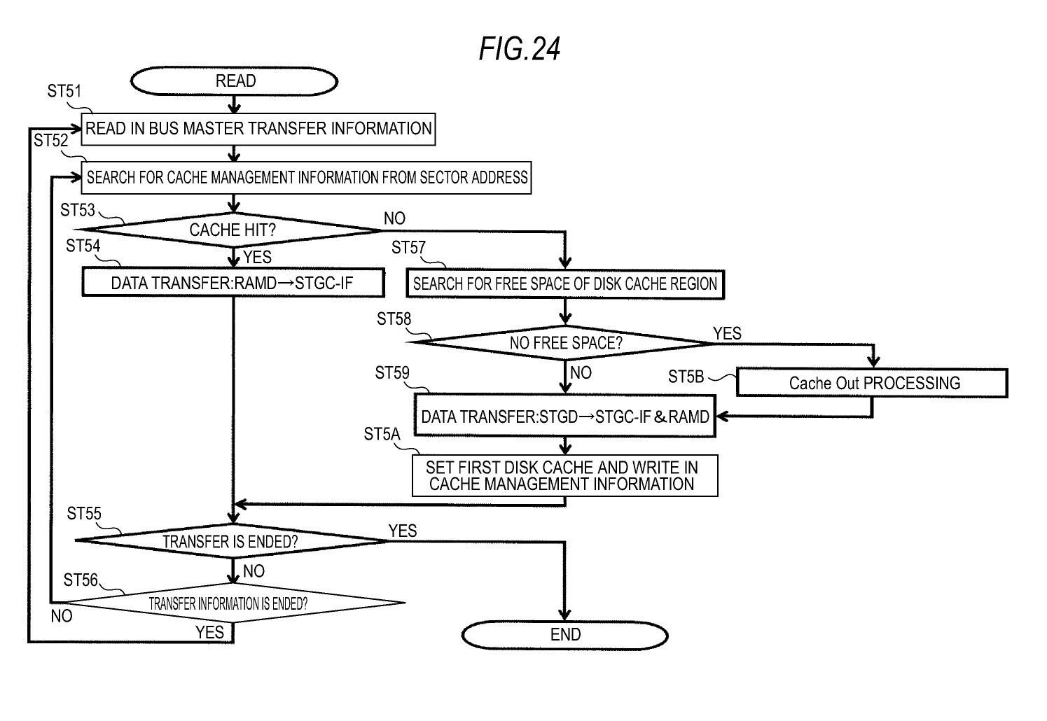

FIGS. 24 to 28 show flowcharts describing STGC internal operations when the four commands are executed.

FIG. 24 shows a flowchart describing an STGC internal operation of the read command.

The operation of command processing is started by writing the operation code of the command in the command register CR of the control register CTRL_REG.

At step ST51, the STGC 21 uses the bus master function to read in the first PRD table entry PRDTE from the PRD table PRDT on the MMM 40.

At step ST52, the STGC 21 searches for the cache management information CMI from the sector address and the sector number written in the control register CTRL_REG.

At step ST53, as a search result, if appropriate data exists on the disk cache (cache hit), at step ST54, the data is transferred to the data buffer region on the MMM 40 using the bus master function.

At step ST55, whether data for the head PRD table entry PRDTE has been completed or not is confirmed and, at step ST56, through determination processing as to whether transfer information is ended or not, returning to step ST51, the next PRD table entry PRDTE is read in.

At step ST53, if cache miss has been determined, at step ST57, a disk cache region DCR for newly reading in data is searched for.

If a new disk cache region is not found, at step ST5B, cache out processing is performed and a free disk region is secured.

At step ST58, if determination that there is a free disk region is made, at step ST59, the data read out from the STGD is transferred to the data buffer region on the MMM 40 using the bus master function, and concurrently, transferred to the cache region newly secured on the RAMD 22.

At step ST5A, registration in the cache management information CMI is performed, through the determination processing as to whether the transfer has been ended or not at step ST55 and the transfer information has been ended or not at step ST56, returning to step ST51, the next PRD table entry PRDTE is read in.

The above described processing is repeated until the command is ended.

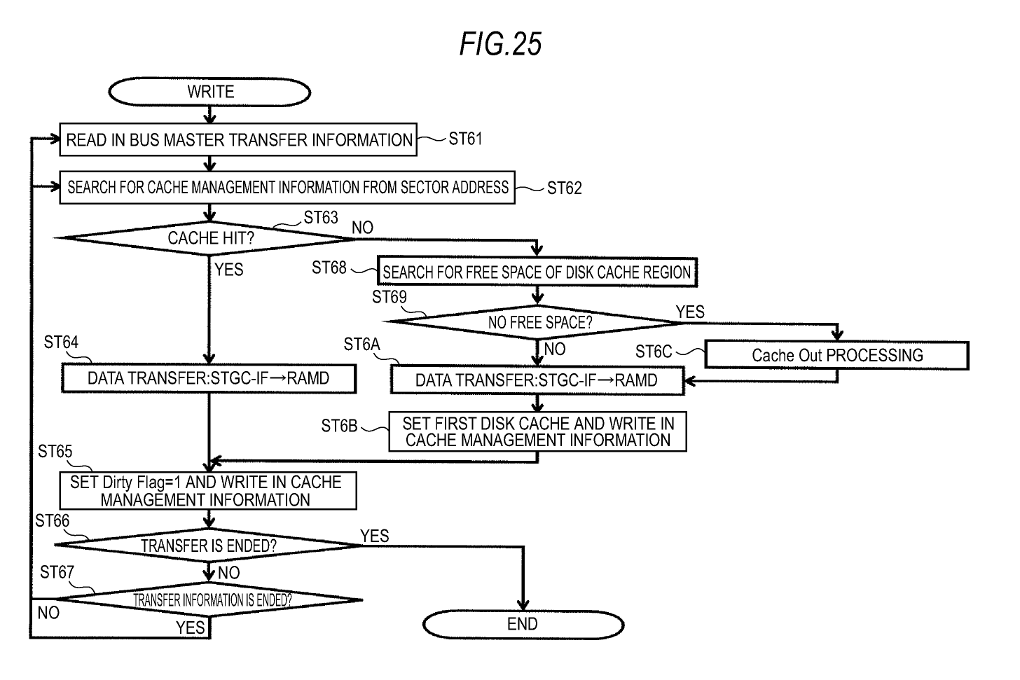

FIG. 25 shows a flowchart describing an STGC internal operation of the write command.

The operation of command processing is started by writing the operation code OC of the command in the command register CR of the control register CTRL_REG.

At step ST61, the STGC 21 uses the bus master function to read in the first PRD table entry PRDTE from the PRD table PRDT on the MMM 40.

At step ST62, the STGC 21 searches for the cache management information from the sector address and the sector number written in the control register CTRL_REG.

At step ST63, if cache miss has occurred, at step ST68, a disk cache region DCR for newly writing in data is searched for. If a new disk cache region is not found, at step ST6C, cache out processing is performed and a free disk region is secured.

At step ST63, if cache hit has been determined, at step ST64, the STGC 21 transfers the data on the MMM 40 to the cache region secured on the RAMD 22 using the bus master function.

At step ST65, the dirty flag (dirty flag bit) DRTF=1 of the cache management information is set.

Then, at step ST66, whether data for the head PRD table entry PRDTE has been completed or not is confirmed and, at step ST67, through determination processing as to whether transfer information is ended or not, returning to step ST61, the next PRD table entry PRDTE is read in.

The above described operation is the same as a basic operation of a general comparative example.

In the embodiment of the invention, on the RAMD 22 controlled by the STGC 21, there are two cache types CTs of the first disk cache and the second disk cache in the data on the disk cache region DCR.

On the other hand, in the comparative example, there is only data corresponding to the first disk cache.

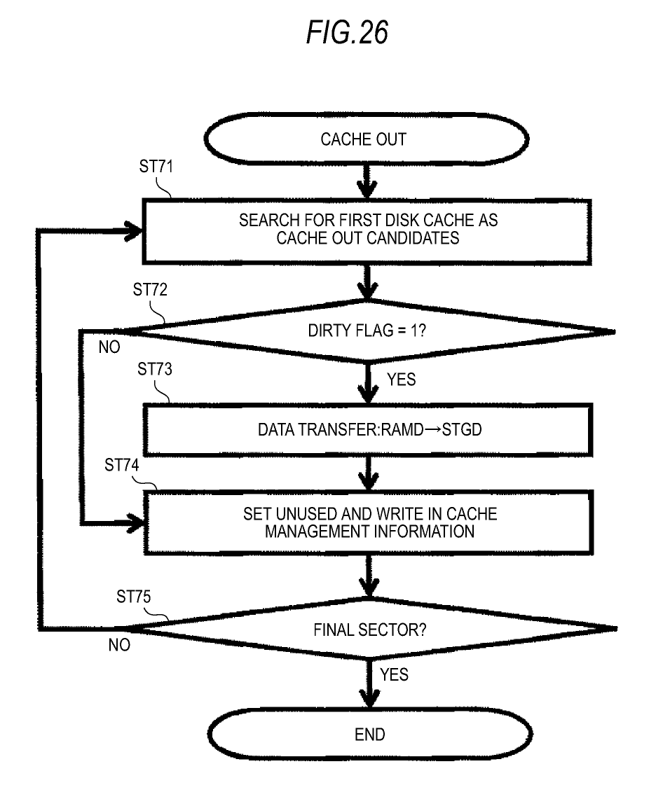

FIG. 26 shows a flowchart describing an STGC internal operation of cache out processing.

At step ST71, the STGC 21 checks sectors as candidates for cache out from the disk cache region.

To determine the candidates, the LRU info in the management information MI of the cache management information CMI is read in and used.

Further, the second disk cache is not used as a candidate for cache out.

At step ST72, if the management information MI of the sectors as the candidate is the dirty flag bit DRTF=1, at step ST73, processing of writing back the sector data currently existing on the RAMD 22 in the STGD 23 is performed.

At step ST74, the cache management information is cleared to be unused.

Regarding the data with the dirty bit DB=0, writing back is not performed and the cache management information is cleared at step ST74.

At step ST75, the above processing is repeated at the necessary sector number until the final sector is determined.

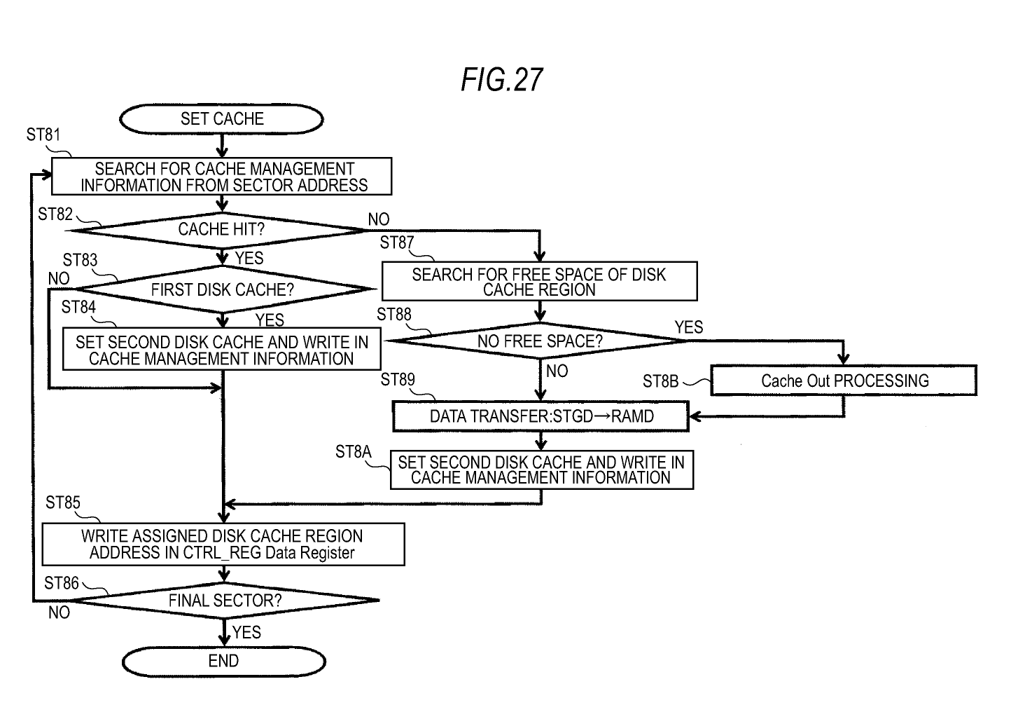

FIG. 27 shows a flowchart describing an STGC internal operation of the set cache command.

At step ST81, the STGC 21 searches for the cache management information from the sector address and the sector number written in the control register CTRL_REG.

At step ST82, if appropriate disk cache data has been found, at step ST83, if the data is the first cache disk, at step ST84, the cache management information is changed and set to second cache disk.

At step ST82, if no appropriate disk cache data exists, at step ST87, a free space is searched for from the disk cache region DCR on the RAMD 22. At step ST88, if a free space is not found, at step ST8B, cache out processing is performed and a free space is prepared.

At step ST88, if the determination that there is a free space is made, at step ST89, appropriate sector data is transferred from the STGD 23 to the disk cache free region secured on the RAMD 22.

Then, at step ST8A, registration is performed as the second disk cache in the cache management information CMI.

At step ST85, the address of the second disk cache on the RAMD 22 assigned to the designated sector data is set in the data register DR of the control register CTRL_REG. When data is set in the data register DR, in the status register of the control register CTRL_REG, DRDY=1, and notification that new data has been set in the data register DR is given. When the data of the data register DR is read out, DRDY=0, and it becomes possible to set the next data in the data register DR.

At step ST86, the above processing is repeated at the sector number set in the sector num SN in the control register CTRL_REG until the final sector is determined.

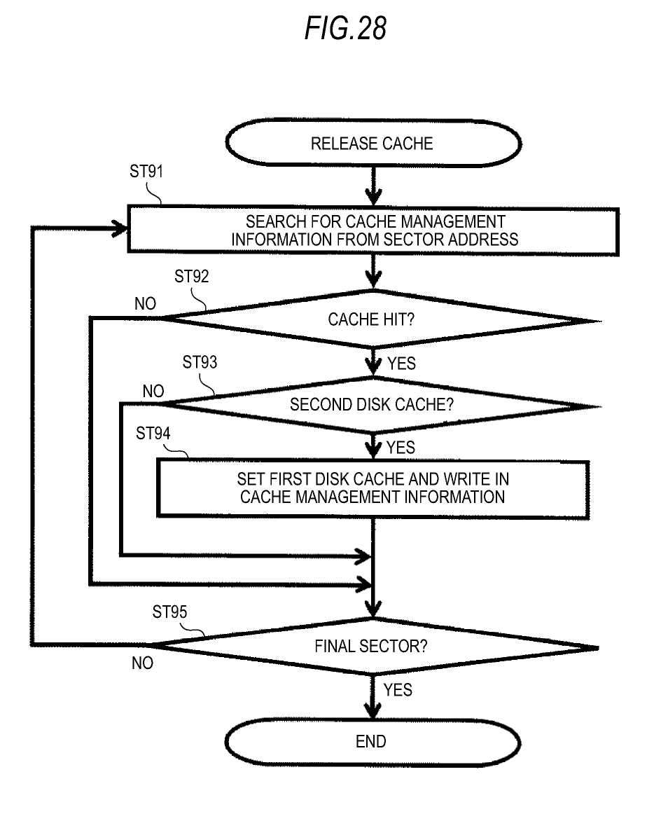

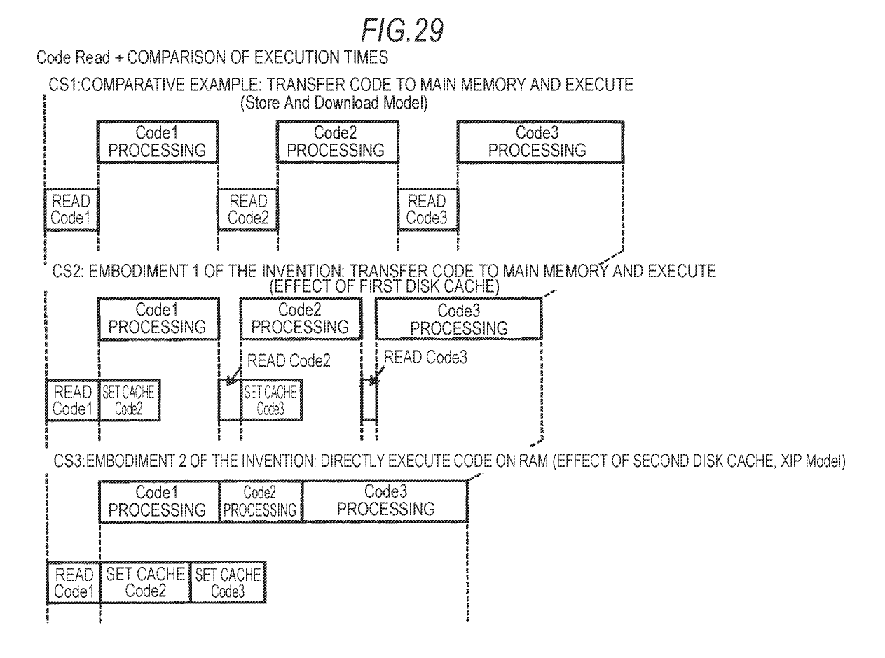

FIG. 28 shows a flowchart describing an STGC internal operation of the release cache command.

At step ST91, the STGC 21 searches for the cache management information CMI from the sector address and the sector number written in the control register CTRL_REG.

At step ST92, if appropriate disk cache data has been found, and further, at step ST93, whether the data is the second cache disk or not is confirmed. Here, if a positive determination (Yes) is obtained, at step ST94, the setting is changed to the first cache disk.

At step ST95, the above processing is repeated at the sector number set in the sector num SN in the CTRL_REG until the final sector is determined.

The data changed to the first disk cache becomes a candidate of the sector for cache out when a free space of the disk cache region is necessary next.

FIG. 29 is a diagram describing and showing effects of the embodiment of the invention by comparison of times from read in of codes saved on a storage onto a memory to execution from the CPU.

In any example, three codes are sequentially loaded and executed.

A case CS1 is an operation of reading in the codes on the memory and executing them in the same manner as in related art (store and download).

Codes CD1 to CD3 are sequentially loaded on the MMM 40 by the read command and executed, and the entire processing time is {T(Read Code1)+T(Exec Code1)+T(Read Code2)+T(Exec Code2)+T(Read Code3)+T(Exec Code3)}.

Here, T(X) is time taken until processing is completed.

Since all of the codes CD1, CD2, CD3 are saved in the different sectors, the effect of the first disk cache is not obtained.

A case CS2 is an operation of shortening the load times of the code CD2, the code CD3 by the set cache command.

The first code CD1 is the read command, and the code CD2 executes the set cache command during execution of the code CD1 and the code CD3 executes the set cache command during execution of the code CD2.

Thereby, the entire processing time is {T(Read Code1)+T (Exec Code1)+T(Read Code2 from Disk Cache)+T(Exec Code2)+T(Read Code3 from Disk Cache)+T(Exec Code3)}.

The load times of the code CD2, the code CD3 are shortened by the effect of the first disk cache.

A case CS3 is an operation of using the second disk cache as it is as a memory for executing the codes CD1, CD2, CD3 (Execute In Place).

All of the codes CD1 to CD3 are loaded on the RAMD 22 as the second disk cache by the set cache command, and the CPU 30 directly accesses from the MEM-IF 25 of the STGC 31 to execute these codes.

The performances of readout of the RAMD 22 and the main memory accessed from the STGC 21 are equal, the transfer time from the STGC onto the MMM is not taken.

Thereby, the entire processing time is {T(Set Cache Code1)+T(Exec Code1)+T(Exec Code2)+T(Exec Code3)}.

The execution of the codes and the access to the RAMD 22 by the execution of the set cache command are arbitrated in the memory control part within the STGC 21. Further, the access from the MEM-IF 25 is given priority, and thus, the processing time of the set cache is longer in some degree, however, the above described entire processing time is taken if it does not exceed the execution time.

Since the real CPU module has an instruction cache and a data cache inside, the influence of extension of the set cache processing time due to arbitration is hard to be greater to exceed the execution time.

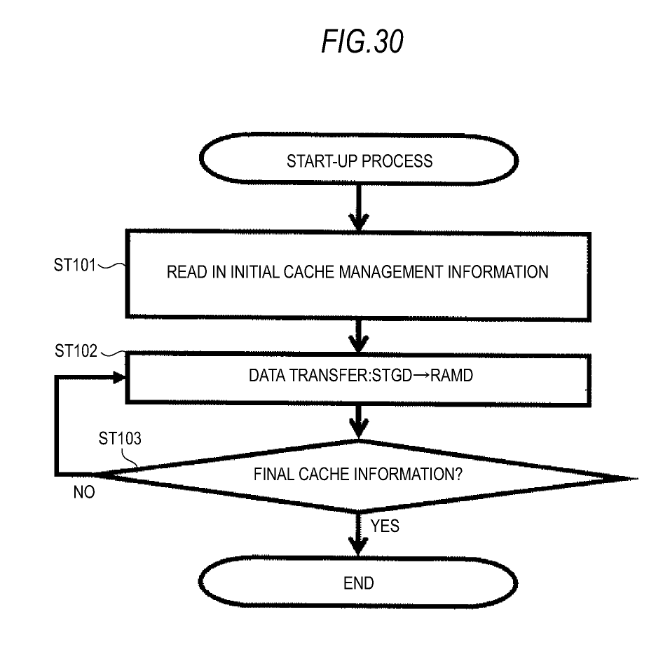

FIG. 30 shows a flowchart describing an operation performed in the STGC when reset of the storage module is released for start-up.

Simultaneously, in parallel, the reset for the STGD 23 and the RAMD 22 is also released.

At step ST101, the STGC 21 loads an initial value of the cache management information in the cache management region CMIR on the RAMD 22.

The initial value is saved on the STGD 23 or saved on the nonvolatile memory region within the STGC 21.

Further, the STGC 21 also provides means for setting the initial value in its saving region.

The disk cache set by the initial value may include either of or both the first disk cache and the second disk cache.

At step ST102, the STGC 21 transfers the sector data from the STGD 23 onto the RAMD 22 according to the initial value.

This processing is repeated until all of the second disk caches registered as the initial values are loaded.

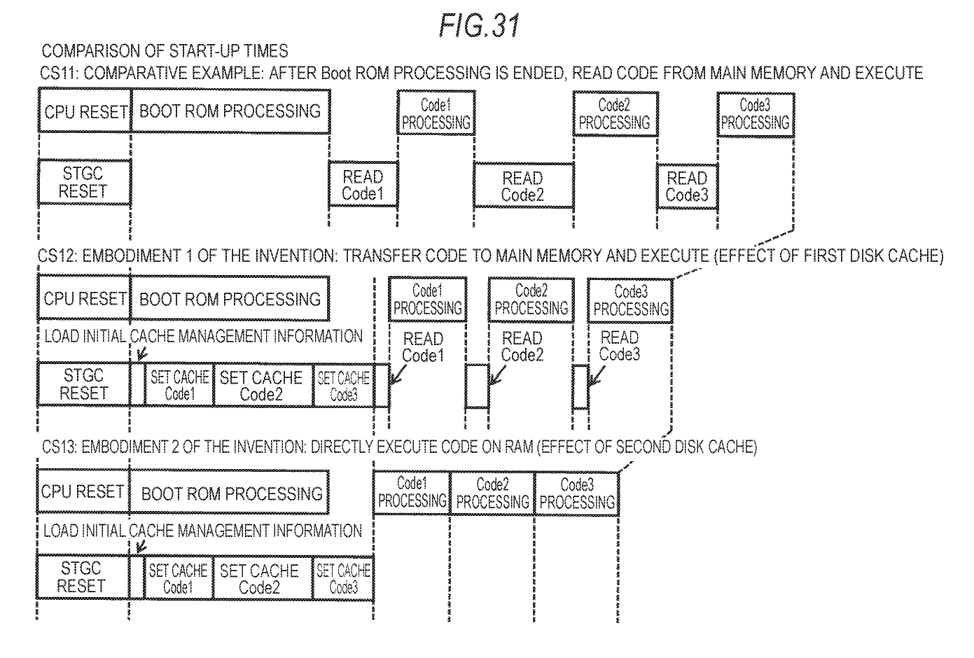

FIG. 31 shows effects of functions of automatically loading initial values of cache management information of the embodiment.

The assumed system executes an initial start-up code from a boot ROM 80 shown in FIGS. 2 and 3, and performs initialization of the CPU peripheral devices, particularly, initialization of the memory controller that controls the MMM 40.

Then, the codes CD1, CD2, CD3 as start-up codes of the OS and the applications are loaded from the STGC 21.

A case CS11 is an operation of starting read in of the start-up code from the STGM 20 after initialization processing of the CPU module 30 by the boot ROM 80 is ended.

The entire processing time is {T(Exec BootROM)+T(Read Code1)+T(ReadCode2)+T(Exec Code2)+T(ReadCode3)+T(Exec Code3)}.

Simultaneously, in parallel, the reset for the RAMD 22 is also released, and the CPU module 30 starts the initialization processing of itself and the initialization of the MMM 40 is generally performed in the initialization processing of the CPU module 30.

Accordingly, it may be impossible to use the external data transfer using the bus master function of the STGC 21 until all initialization processing is ended.

The case CS11 describes such a comparative example, and the start-up code of the CPU module 30 is executed from on the boot ROM 80 and, after the execution is ended, the codes CD1, CD2, CD3 are sequentially loaded on the MMM 40 and executed (Store And Download).

All the time, codes CD11 to CD13 are accessed for the first time after power supply is turned on, and the effect of the disk cache is not obtained.

A case CS12 loads the codes CD11 to CD13 as start-up processing of the STGC 21 as the second disk cache before the start-up processing of the CPU module 30 is ended using the set cache command. The case CS12 is an example of shortening the start-up time by that.

The CPU module 30 uses the read command for loading the code for the STGD 23 after the start-up processing is ended, and thus, the cache data on the RAMD 22 is made faster by the operation as the first disk cache.

A case CS13 directly executes the codes CD11 to CD13 without transferring them to the MMM 40 as start-up processing of the STGC 21. Thereby, the case CS13 is an example of shortening the start-up time without the necessity of the data transfer time from the STGM 20 to the MMM 40 (the effect of the second disk cache, Execute In Place).

After the start-up processing is ended, all of these second disk cache data can be released using the release cache command.

### 2. Second Embodiment

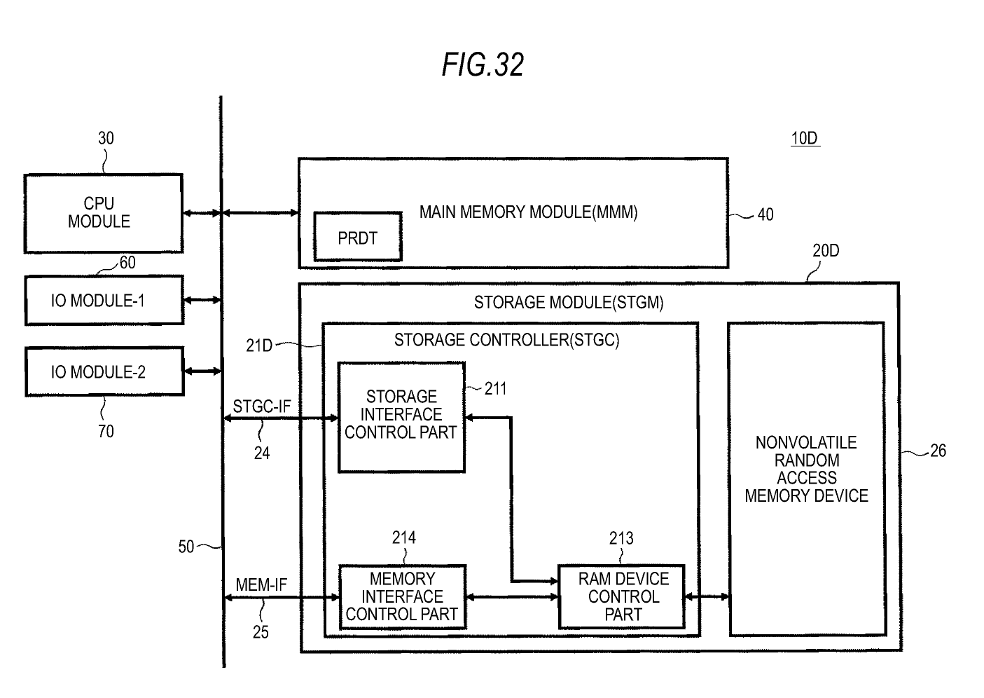

FIG. 32 shows a configuration example of a memory system including a storage unit according to the second embodiment of the invention.

A memory system 10D according to the second embodiment is different from the above described memory system 10 according to the first embodiment in the following points.

That is, in the second embodiment, in a storage module 20D, a nonvolatile random access memory (NVRAM) 26 that is a nonvolatile memory device and may be used as a random access memory is used as an STGD.

The STGD is accessible as a RAM, and generally, the address space on the system bus is smaller than the entire storage space.

Therefore, the memory interface control part 214 may have a function of performing conversion into an NVRAM address that determines the address on the MEM-IF 25 for access to the data from the system bus 50 when the set cache command is executed.

Further, the cache management information is saved in a predetermined region on the NVRAM 26, and there are two of a cache management information region used for work and a region for saving the cache management information for start-up.

As explained above, according to the embodiment, the following advantages may be obtained.

The storage module according to the embodiment uses the random access memory device inside as the first and second disk caches, and thus, the performance as the system can be improved.

In the embodiment, the function of the second disk cache is realized on the storage module, and thus, the reduction of the use efficiency of the disk cache because of holding the overlapping data with the first disk cache can be avoided and the effect of the disk cache for capacity can be improved.

Further, according to the embodiment, compared to the system using the main memory as the second disk cache, the improvement of the performance because of occurrence of no data transfer between the main memory and the storage module can be realized.

At the same time, the use efficiency of the main memory can also be improved and the reduction of the system performance due to occurrence of swap can be prevented.

Furthermore, the general first disk cache has no function of designating data held on the cache from the CPU.

On the other hand, in the embodiment, the data designated as the second disk cache may also be used as the data of the first disk cache.

From this, as a result, the data designated from the CPU may be held as the first disk cache, the number of accesses to the storage device can be reduced, and the improvement of the performance can be realized.

Further, the embodiment has a function of holding the instructions of the cache setting function set for start-up that the storage controller has in a partial region of the nonvolatile memory or the storage device. Furthermore, the embodiment has a function of reproducing the instructions held in the region on the disk cache when the storage module is started. In the embodiment, the improvement of the system start-up time can be realized by these functions.

In a general memory system, the access to the necessary data is started on the storage after the start-up processing of the CPU module is completed and the access to the main memory and the storage module can be made. Accordingly, there is a large time lag until the necessary data is developed on the memory from the storage.

On the other hand, in the embodiment, the storage module itself can develop the data on the disk cache as an initial state.

Therefore, according to the embodiment, the effects of the first and second disk caches are exerted at the maximum immediately after the start-up of the CPU module is completed, and the start-up time of the system can be shortened.

The present application contains subject matter related to that disclosed in Japanese Priority Patent Application JP 2009-237503 filed in the Japan Patent Office on Oct. 14, 2009, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. A storage unit comprising:
a random access memory device to be accessed using an address in units of word;
a storage device to be accessed using an address in units of sector; and
a storage controller that controls accesses to the random access memory device and the storage device according to the addresses designated via a bus,
wherein the storage controller includes
a first interface function for access to data stored on the storage device designated using the sector address provided via the bus,
a second interface function for direct access to data on the random access memory device using the word address designated via the bus,
a function of using the random access memory device as a first disk cache and determining data to be saved in the random access memory device in response to the access by the first interface function,
a function of transferring the data designated using the sector address by repeating register access, and
a function of transferring the data designated using the sector address by a bus master function as continuous word-sized data through the bus.

2. The storage unit according to claim 1, wherein the storage controller includes:
a cache designation function of designating the data held on the random access memory device as a second disk cache via the bus; and
a cache release function of releasing cache designation.

3. The storage unit according to claim 2, wherein the cache designation function is instructed to the storage controller via the first interface function,
the instruction includes information on the address and a data size of the storage device, and
the storage controller secures a region in a designated data size from an unused region on the random access memory device and performs writing processing of the data with the address designated from the storage device in the region previously secured.

4. The storage unit according to claim 2, wherein the cache release function is instructed to the storage controller via the first interface function,
the instruction includes information on the address of the storage device, and
the storage controller determines, regarding a region of the data designated on the random access memory device, whether to hold the data on the random access memory device or not after a release instruction.

5. The storage unit according to claim 2, wherein the data held as the second disk cache is also usable as the first disk cache, and
the storage controller has a function of, if the data designated as the second disk cache has already existed as the first disk cache on the random access memory device, switching the data to data of the second cache data.

6. The storage unit according to claim 2, wherein the storage controller performs write back processing of the data held on the random access memory device as the first disk cache in the storage device according to judgment of itself, and continues to hold the data held on the random access memory device as the second disk cache until it receives the release instruction.

7. The storage unit according to claim 2, wherein the storage controller has an arbiter for arbitrating and switching a signal for transmitting an access as the first disk cache to the random access memory device and a signal for directly transmitting an access from the bus as the second disk cache.

8. The storage unit according to claim 1, wherein the storage controller has:
a function of holding cache management information in a nonvolatile memory; and
a function of reproducing instructions held in the nonvolatile memory at start-up.

9. The storage unit according to claim 1, wherein the random access memory device and the storage device are formed by a nonvolatile random access memory having functions of the random access memory device and the storage device in combination.

10. The storage unit according to claim 9, wherein the memory controller has a path for direct access to the nonvolatile random access memory via the second interface function.

11. A memory system comprising:
a host;
a main memory module;
a storage unit accessed by the host; and
a system bus connecting the host, the main memory module, and the storage unit,
wherein the storage unit includes
a random access memory device to be accessed using an address in units of word,
a storage device to be accessed using an address in units of sector, and
a storage controller that controls accesses to the random access memory device and the storage device according to the addresses designated via the system bus, and
wherein the storage controller includes
a first interface function for access to data stored on the storage device designated using the sector address according to an instruction from the host via the system bus,
a second interface function by the host for direct access to data on the random access memory device using the word address designated via the system bus,
a function of using the random access memory device as a first disk cache and determining data to be saved in the random access memory device in response to the access by the first interface function,
a function of transferring the data designated using the sector address by repeating register access, and
a function of transferring the data designated using the sector address by a bus master function as continuous word-sized data between the main memory module and itself through the system bus.

12. The memory system according to claim 11, wherein the storage controller includes:
a cache designation function by the host of designating the data held on the random access memory device as a second disk cache via the bus; and
a cache release function of releasing cache designation.

13. The memory system according to claim 12, wherein the cache designation function is instructed to the storage controller via the first interface function,
the instruction includes information on the address and a data size of the storage device, and
the storage controller secures a region in a designated data size from an unused region on the random access memory device and performs writing processing of the data with the address designated from the storage device in the region previously secured.

14. The memory system according to claim 12, wherein the cache release function is instructed to the storage controller via the first interface function,
the instruction includes information on the address of the storage device, and
the storage controller determines, regarding a region of the data designated on the random access memory device, whether to hold the data on the random access memory device or not after a release instruction.

15. The memory system according to claim 12, wherein the data held as the second disk cache is also usable as the first disk cache, and
the storage controller has a function of, if the data designated as the second disk cache has already existed as the first disk cache on the random access memory device, switching the data to data of the second cache data.

16. The memory system according to claim 12, wherein the storage controller performs write back processing of the data held on the random access memory device as the first disk cache in the storage device according to judgment of itself, and continues to hold the data held on the random access memory device as the second disk cache until it receives the release instruction.

17. The memory system according to claim 12, wherein the storage controller has an arbiter for arbitrating and switching a signal for transmitting an access as the first disk cache to the random access memory device and a signal for directly transmitting an access from the bus as the second disk cache.

18. The memory system according to claim 11, wherein the storage controller has:
a function of holding cache management information in a nonvolatile memory; and
a function of reproducing instructions held in the nonvolatile memory at start-up.

19. The memory system according to claim 11, wherein the random access memory device and the storage device are formed by a nonvolatile random access memory having functions of the random access memory device and the storage device in combination.

20. The memory system according to claim 19, wherein the memory controller has a path for direct access to the nonvolatile random access memory via the second interface function.
